(19) United States
(12) Patent Application Publication
(10) Pub. No.: US 2013/0220498 A1
(43) Pub. Date: Aug. 29, 2013

(54) TIRE

(71) Applicant: Yuki Kawakami, Pomezia (IT)

(72) Inventor: Yuki Kawakami, Pomezia (IT)

(73) Assignee: BRIDGESTONE CORPORATION, Chuo-ku, Tokyo (JP)

(21) Appl. No.: 13/819,041

(22) PCT Filed: Aug. 26, 2011
(86) PCT No.: PCT/JP2011/069336

§ 371 Date: May 2, 2013

(30) Foreign Application Priority Data
Aug. 26, 2010 (JP) 2010-189647

(51) Int. Cl. B60C 13/02

(52) U.S. Cl. CPC B60C 13/02
USPC 152/209.1; 152/523

(57) ABSTRACT

A pneumatic tire (1) is provided with protrusions (200) formed on a side surface of circumferential land sections (30A, 30B, 30C) that is parallel to the tire circumference, said protrusions (200) protruding in the tread-width direction from said side surface. The protrusions (200) are formed on a buttress section (14), on the side surface of the island unit blocks (100) that is parallel to tire circumference. The protrusions (200) in the pneumatic tire (1) are positioned farther on the outside of the tire radially than the line (BL) joining the groove bottoms (40Ab) of transverse grooves (40A) formed before and after the land blocks (100) in the tire-circumferential direction.

### TECHNICAL FIELD

The present invention relates to a tire including: a bead portion; a sidewall portion continuously extended from the bead portion; a tread portion configured to come into contact with a road surface; and a buttress portion extending inward in a tire radial direction from a tread end portion and continuously extended from the sidewall portion, the tread end portion being an outer end portion of the tread portion in a tread width direction.

### BACKGROUND ART

Rubber materials having viscoelastic properties exhibit hysteresis behavior. Thus, a tire's tread portion generates heat as it deforms and contracts repeatedly through rotation. Increase in the amount of the rubber material constituting the tread portion leads to increase in the hysteresis loss due to the bending deformation and shearing deformation in rotation of the tire. Accordingly, a tire with a thicker tread portion is more likely to experience temperature increase.

Specifically, large-sized tires designed for large-sized vehicles for use in mines, construction sites, etc. contain a large amount of rubber material used therein and, in addition, are used with heavy loads thereon on rough road surfaces under harsh traction conditions. Since tires deform and contact repeatedly, large tires are characterized as being more likely to generate heat. If a tire's temperature becomes high during travel, that temperature can lead, for example, to separation of the rubber material forming the tread portion from the belt layer, which in turn shortens the tire replacement cycle.

In this respect, methods have heretofore been known in which sub-grooves extending in the tread width direction are formed in the tread portion to reduce the amount of the rubber material being a source of the heat generation, and also to increase the surface area of the tread portion to thereby facilitate heat dissipation of the tread portion (Patent Document 1, for example).

### PRIOR ART DOCUMENT

### Patent Document

Patent Document 1: Japanese Patent Application Publication No. 2003-205706, FIG. 1 and the like

### SUMMARY OF THE INVENTION

However, the conventional tires have the following problem. The heat dissipation can be facilitated by forming lateral grooves (sub-grooves) crossing the tire circumferential direction and thus increasing the groove area. Increasing the groove area, however, leads to reduction in the rigidity of the tread portion and reduction in the wear resistance thereof. As described above, there is a trade-off between the heat dissipation performance of a tire and the rigidity of the tire. Hence, there is a limitation in securing the heat dissipation performance by increasing the groove area.

Therefore, an object of the present invention is to provide a tire capable of securely achieving improved heat dissipation performance without impairing the rigidity and wear resistance of its tread portion.

To solve the above problem, a feature of the present invention is summarized as a tire comprising: a bead portion (bead portion 11); a sidewall portion (sidewall portion 12) continuously extended from the bead portion; a tread portion (tread portion 13) that comes into contact with a road surface; and a buttress portion (buttress portion 14) extending inward in a tire radial direction from a tread end portion (tread end portion 13e) and continuously extended from the sidewall portion, the tread end portion being an outer end portion of the tread portion in a tread width direction, wherein a protrusion (protrusion 200) protruding in the tread width direction is formed in the buttress portion.

In the tire according to the present invention, the protrusion is formed in the buttress. Thus, an airflow around the tire is disturbed by the protrusion and taken into the corresponding lateral groove portion, thereby increasing the flow volume of air flowing inside the lateral groove. As a result, the heat transfer coefficient inside the lateral groove is improved. Accordingly, the temperature of the land portions can be reduced. Further, the temperature of the tread portion can be lowered.

A second feature of the present invention is summarized as a tire comprising: a bead portion; a sidewall portion continuously extended from the bead portion; a tread portion that comes into contact with a road surface; and a buttress portion extending inward in a tire radial direction from a tread end portion and continuously extended from the sidewall portion, the tread end portion being an outer end portion of the tread portion in a tread width direction, wherein a rotation direction of the tire during forward travel of a vehicle is fixed, a plurality of lateral groove portions, a circumferential groove portion, and land portions are formed in the tread portion, the lateral groove portions crossing a tire circumferential direction, the circumferential groove portion extending in the tire circumferential direction, the land portions being defined by the lateral groove portions and the circumferential groove portion, a protrusion is formed on a side surface of each of the land portions that crosses the tread width direction, the protrusion protruding in the tread width direction from the side surface and extending in the tire radial direction, and an air gap is formed between a most protruded portion of the protrusion from the side surface in the tread width direction and a side surface of an adjacent land portion in the tread width direction crossing the tread width direction.

In the tire according to the present invention, the protrusion is formed on the side surface of each of the land portions that crosses the width direction of the tread portion. Thus, air flowing over the surface of the tire hits the protrusion and gets disturbed. Since the protrusion is located near each of the lateral grooves formed between the land portions, an airflow around the tire is disturbed by the protrusion and thereby taken into the lateral groove.

The air gap is formed between the most protruded portion of the protrusion from the side surface in the tread width direction and the side surface of the adjacent land portion in the width direction of the tread portion crossing the width direction of the tread portion. Thus, air taken into the circumferential groove portion flows into the lateral groove portion. As a result, the heat transfer coefficient inside the lateral groove is improved. Accordingly, the temperature of the land portions can be reduced. Further, the temperature of the tread portion can be lowered.

The protrusion may be formed near the lateral groove located on one side with respect to a center of the land portion in the circumferential direction, and the other side of the side surface with respect to the center of the land portion in the circumferential direction may be almost flat and smooth.

The protrusion may have a rectangular shape extending in the tire radial direction, and p<0.4 W may be satisfied, where p is a length, within a section of the land portion defined by the lateral groove portions, from an end portion of the side surface in the tire circumferential direction to a protrusion center line set at a center of the protrusion in the tire circumferential direction and extending in a lengthwise direction of the protrusion, and W is a pitch of the lateral groove portions between the land portions.

An angle θ between the protrusion center line and a tire normal line may satisfy |θ|≦60°.

The tire normal line may coincide with the lengthwise direction of the rectangular shape.

2.00≦W/Lw may be satisfied, where Lw is a length of the protrusion in the tread width direction, and W is a pitch of the lateral groove portions.

0≦Lr<WB/2 may be satisfied, where WB is a length of each of the land portions in the tire circumferential direction, and Lr is a length of the protrusion in the tire circumferential direction.

0.10≦Lh/H may be satisfied, where Lh is a length of the protrusion in the tire radial direction, and H is a length of each of the land portions in the tire radial direction from a groove bottom of each of the lateral groove portions defining the land portions.

The lateral groove portions may be tilted with respect to a tread-width-direction line extending in the tread width direction, and the protrusion may be provided in an end-portion region including an end portion of the corresponding land portion on a side where an angle between a side surface of the land portion extending in the tire circumferential direction and a wall surface of the corresponding lateral groove portion is an acute angle.

A circumferential groove portion extending in the tire circumferential direction may be formed, and the lateral groove portions may communicate with the circumferential groove portion.

### BRIEF DESCRIPTION OF THE DRAWINGS

FIG. 1 is a perspective view of a pneumatic tire according to an embodiment.

FIG. 2 is a cross-sectional view of the pneumatic tire according to the embodiment taken along the tread width direction and the tire radial direction.

FIG. 3 is an enlarged perspective view of an enlarged version of the tread of the pneumatic tire.

FIG. 4 is a side view seen in the direction of an arrow A in FIG. 3.

FIG. 5 is a plan view seen in the direction of an arrow B in FIG. 3. Portion (a) of FIG. 5 is a schematic view describing airflows generated when the pneumatic tire 1 is rotated in a rotation direction R1, while Portion (b) of FIG. 5 is a schematic view describing airflows generated when the pneumatic tire 1 is rotated in a rotation direction R2.

FIG. 6 Portion (a) of FIG. 6 is a schematic view describing airflows generated when a pneumatic tire 2 is rotated in the rotation direction R1, while Portion (b) of FIG. 6 is a schematic view describing airflows generated when the pneumatic tire 2 is rotated in the rotation direction R2.

FIG. 7 is a plan view of a pneumatic tire seen in a direction perpendicular to its tread surface, the pneumatic tire being shown as a modification of the embodiment.

FIG. 8 is a view describing modifications of the shape of protrusions of the embodiment.

### MODES FOR CARRYING OUT THE INVENTION

Embodiments of a pneumatic tire 1 according to the present invention will be described with reference to the drawings. Specifically, description will be given of (1) Inner Configuration of Pneumatic Tire, (2) Description of Protrusions, (3) Operations and Effects, (4) Modifications, and (5) Other Embodiments.

Note that, in the following description of the drawings, the same or similar reference numerals denote the same or similar portions. However, it should be noted that the drawings are schematic, and dimensional ratios and the like are different from the actual ones. Therefore, specific dimensions and the like should be determined in consideration of the following description. Moreover, the drawings also include portions having different dimensional relationships and ratios from each other.

### (1) Configuration of Pneumatic Tire

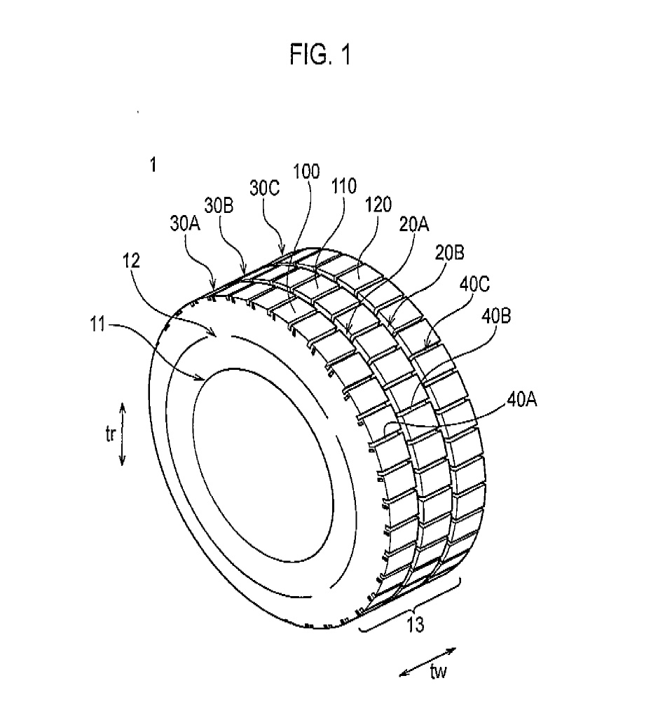

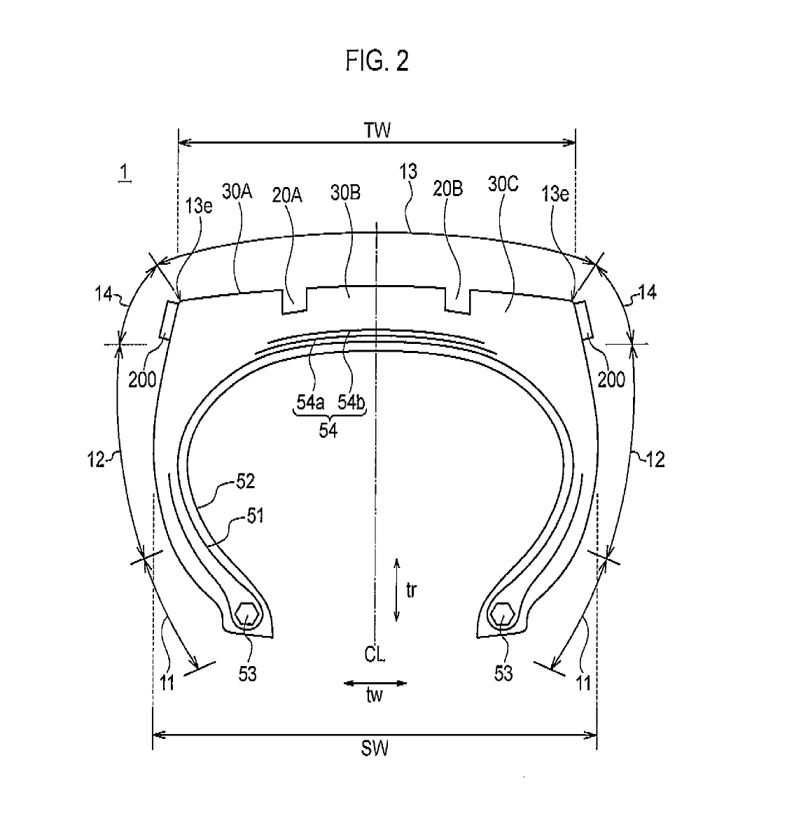

FIG. 1 is a perspective view of the pneumatic tire 1 according to an embodiment. FIG. 2 is a cross-sectional view of the pneumatic tire 1 taken along a tread width direction tw and a tire radial direction tr.

As shown in FIG. 2, the pneumatic tire 1 includes: bead portions 11 in contact with rims; sidewall portions 12 forming the side surfaces of the tire; a tread portion 13 configured to come into contact with the road surface; and buttress portions 14 located between the sidewall portions 12 and the tread portion 13, respectively.

The buttress portions 14 are located as extensions of the sidewall portions 12 in the tire radial direction and are portions that connect to the side surfaces of the tread portion 13, respectively. The buttress portions 14 extend inward in the tire radial direction tr from tread end portions 13e which are outer end portions of the tread portion 13 in the tread width direction, respectively. The buttress portions 14 are portions configured not to come into contact with the ground during normal travel.

Circumferential grooves 20A and 20B extending in the tire circumferential direction are formed in the tread portion 13. Moreover, circumferential land portions 30A, 30B, and 300 are formed which are defined by the circumferential grooves 20A and 20B.

As show in FIG. 1, lateral grooves 40A crossing the tire circumferential direction are formed in the circumferential land portion 30A. Lateral grooves 40B crossing the tire circumferential direction are formed in the circumferential land portion 30B. Lateral grooves 40C crossing the tire circumferential direction are formed in the circumferential land portion 300. The circumferential land portions 30A, 30B, and 30C are divided by their lateral grooves 40A, 40B, and 40C to form land-portion blocks 100, 110, and 120. Moreover, the lateral grooves 40A, 40B, and 400 communicate with the circumferential groove 20A or 20B.

The pneumatic tire 1 includes a carcass layer 51 serving as a frame of the pneumatic tire 1. Provided on the inner side, in the tire radial direction, of the carcass layer 51 is an inner liner 52 being a highly airtight rubber layer equivalent to a tube. Both ends of the carcass layer 51 are supported by a pair of beads 53.

A belt layer 54 is arranged on the outer side, in the tire radial direction, of the carcass layer 51. The belt layer 54 includes a first belt layer Ma and a second belt layer 54b which are rubber-coated steel cords. The steel cords forming the first belt layer 54a and the second belt layer 54b are each arranged at a certain angle with respect to a tire equator line CL. The tread portion 13 is arranged on the outer side, in the tire radial direction, of the belt layer 54 (the first belt layer 54a and second belt layer 54b).

The pneumatic tire 1 includes, in each buttress portion 14, protrusions 200 protruding in the tread width direction.

SW represents the total width of the pneumatic tire in the tread width direction. TW represents the width of the tread portion 13 of the pneumatic tire 1 in the tread width direction. The pneumatic tire 1 may be filled with an inert gas such as nitrogen gas instead of air. In the embodiment, the pneumatic tire 1 is, for example, a radial tire having an aspect ratio of 80% or smaller, a rim diameter of 57″ or greater, a load bearing capacity of 60 mton or greater, and a load factor (k-factor) of 1.7 or greater.

### (2) Description of Protrusions

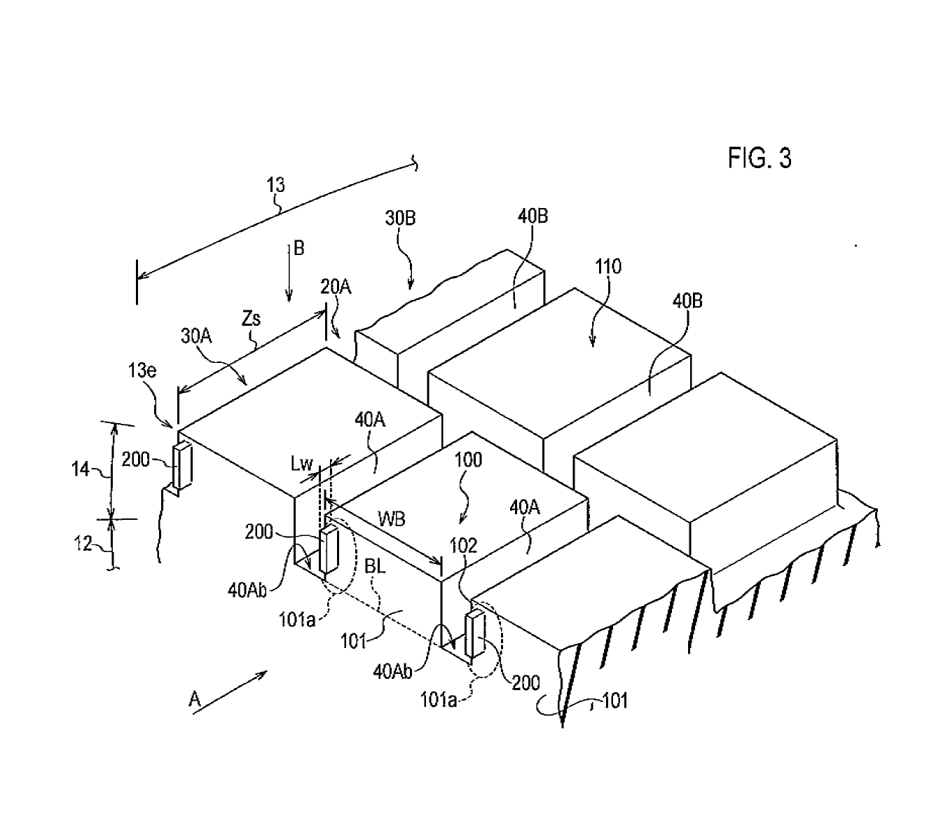

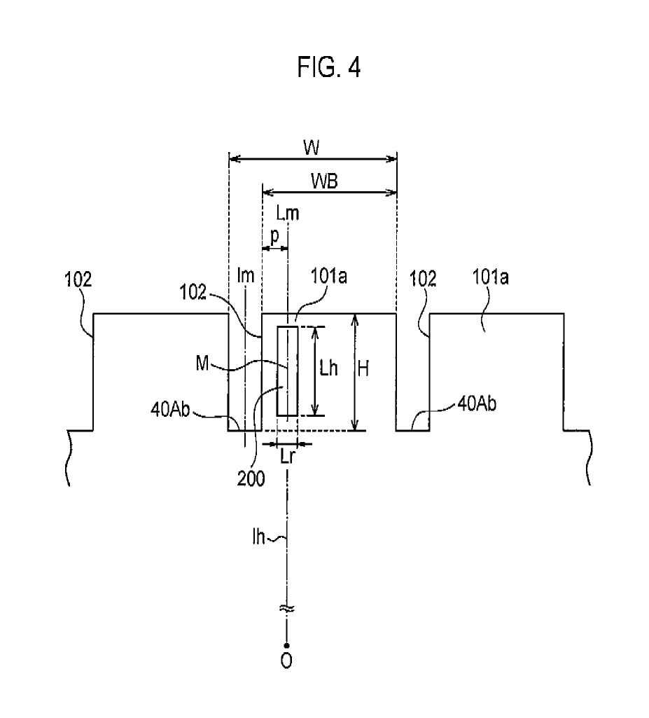

FIG. 3 is an enlarged perspective view of an enlarged version of the tread portion 13 of the pneumatic tire 1. FIG. 4 is a side view seen in the direction of an arrow A in FIG. 3.

Each protrusion 200 is formed on a side surface 101 of the land-portion block 100 near the lateral groove located on one side with respect to the center of the land-portion block 100 in the tire circumferential direction. Specifically, the protrusion 200 is provided in an end-portion region 101a including an end portion 102 of the side surface 101 of the land-portion block 100 in the tire circumferential direction. The other side of the side surface 101 with respect to the center of the land-portion block 100 in the circumferential direction is almost flat and smooth. Here, being almost flat and smooth refers to a state where slight asperities due to manufacturing errors are tolerated. The slight asperities refer, for example, to asperities within ±10% of a length Zs of the land-portion block 100 in the tread width direction.

The length of the protrusion 200 in the tire circumferential direction is smaller than a length WB of the land-portion block 100, which is defined by the lateral grooves 40A formed in the circumferential land portion 30A, in the tire circumferential direction.

The protrusion 200 has a rectangular shape extending straightly in the tire radial direction. The lengthwise direction of the rectangular shape may be tilted with respect to the tire radial direction. In this case, an angle θ between a protrusion center line Lm set at a center M of the protrusion 200 in the tire circumferential direction and a tire normal line Ih may be |θ|≦60°. In the embodiment, the protrusion 200 is arranged such that the tire radial direction and the lengthwise direction of the rectangular shape coincide with each other and that the tread width direction and the widthwise direction of the rectangular shape coincide with each other.

The pneumatic tire 1 satisfies the following formula, where Lw is the length of the protrusion 200 in the tread width direction from the side surface 101 of the land-portion block 100, SW is the total width of the pneumatic tire 1, and TW is the width of the tread portion 13 (see FIG. 1).

Lw≦(SW−TW)/2

Moreover, the pneumatic tire 1 satisfies the following formula, where Lh is defined as the length of the protrusion 200 in the tire radial direction, and H is defined as the length of the land-portion block 100 in the tire radial direction from a groove bottom 40Ab.

0<H/Lh≦10

Furthermore, the pneumatic tire 1 satisfies the following formulas, where p is the length from the end portion 102 of the side surface 101 of the land-portion block 100 in the tire circumferential direction to the protrusion center line Lm set at the center M of the protrusion 200 in the tire circumferential direction, Lw is the length of the protrusion 200 in the tread width direction, W is the pitch of the lateral grooves 40, WB is the length of the land-portion block 100 in the tire circumferential direction, and Lr is the length of the protrusion 200 in the tire circumferential direction.

0<p/Lw<20

p<WB

p<0.4 W

0≦Lw<W/2

0≦Lr<WB/2

### (3) Operations and Effects

In the pneumatic tire 1, the protrusions 200 are formed in each buttress portion 14 being a side surface of each land-portion 100 parallel to the tire circumferential direction. Thus, the protrusions 200 receive relative winds generated by rotation of the pneumatic tire 1 in the direction opposite to the direction of the rotation. Airflows passing over the surface of the pneumatic tire 1 are disturbed by hitting the protrusions 200 and taken into the lateral grooves 40 formed between the land-portion blocks 100.

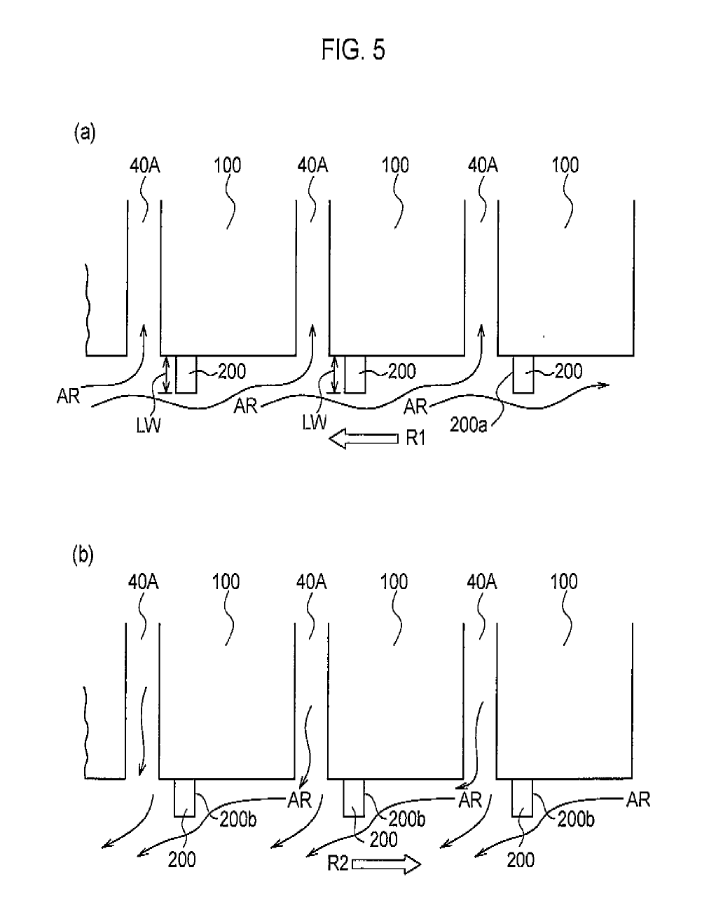

Portion (a) of FIG. 5 is a plan view seen in the direction of an arrow B in FIG. 3 and is a schematic view describing airflows generated when the pneumatic tire 1 is rotated in a rotation direction R1. Portion (b) of FIG. 5 is a plan view seen in the direction of the arrow B in FIG. 3 and is a schematic view describing airflows generated when the pneumatic tire 1 is rotated in a rotation direction R2.

As shown in Portion (a) of FIG. 5, when the pneumatic tire 1 is rotated in the rotation direction R1, airflows (relative winds) AR resulting from the rotation hit side surfaces 200a of the protrusions 200 formed in the buttress portion 14 and are taken into the lateral grooves 40A, As described above, the airflows AR around the pneumatic tire 1 are taken into the lateral grooves 40A, thereby increasing the flow volumes of air flowing inside the lateral grooves 40A. As a result, the heat transfer coefficient inside the lateral grooves 40A is improved. Accordingly, increase in the temperature of the land-portion blocks 100 can be reduced. Further, increase in the temperature of the tread portion 13 can be reduced.

Moreover, as shown in Portion (b) of FIG. 5, when the pneumatic tire 1 is rotated in the rotation direction R2, airflows (relative winds) AR resulting from the rotation hit side surfaces 200b of the protrusions 200 formed in the buttress portion 14 and flow over the protrusions 200. When this occurs, an airflow toward the outer side in the width direction is generated in the rear, in the rotation direction, of the side surface 200b of each of the protrusions 200. These airflows suck air through the lateral grooves 40A and the circumferential groove 20A and thus generate the airflows AR flowing outward from the lateral grooves 40A. As a result, the heat transfer coefficient inside the lateral grooves 40A is improved. Accordingly, increase in the temperature of the land-portion blocks 100 can be reduced. Further, increase in the temperature of the tread portion 13 can be reduced.

Each protrusion 200 has a rectangular shape extending straightly in the tire radial direction, and the tire radial direction and the lengthwise direction of the rectangular shape may be tilted from each other. In this case, the angle θ between the protrusion center line Lm set at the center M of the protrusion 200 in the tire circumferential direction and the tire normal line may be |0|≦60°.

Moreover, each protrusion 200 may be arranged such that the lengthwise direction of the rectangular shape of the protrusion 200 and the tire radial direction (i.e. the tire normal line 1h) coincide with each other and that the tread width direction and the widthwise direction of the rectangular shape coincide with each other. By such an arrangement, it is possible to efficiently produce a pressure difference between the front and rear of the protrusion 200.

The length Lw of each protrusion 200 in the tread width direction satisfies Lw≦(SW−TW)/2. That is, the protrusion 200 does not protrude beyond the total width SW of the pneumatic tire 1 outwardly in the tread width direction. It is undesirable for the protrusion 200 to have its end beyond the total width SW of the pneumatic tire 1 because such a state increases the risk of the end contacting obstacles or the like.

The length Lh of each protrusion 200 in the tire radial direction satisfies 0.10≦Lh/H. That is, when the length Lh of the protrusion 200 in the tire radial direction is below 10% of that of the land-portion block 100, the effect of generating the airflows AR upon the rotations of the pneumatic tire 1 in the directions R1 and R2 becomes low. This makes it difficult to improve the heat transfer coefficient inside each lateral groove 40A.

The length Lw of each protrusion 200 in the tread width direction from the side surface of the land-portion block 100 satisfies 0≦p/Lw<20. When p/LW exceeds this range, i.e. when the protrusion 200 is too far from the lateral groove 40, the effect of generating the airflows AR becomes low. Moreover, the protrusion 200 is such that the length p from the end portion 102 of the side surface 101 of the land-portion block 100 in the tire circumferential direction to the protrusion center line Lm set at the center M of the protrusion 200 in the tire circumferential direction and extending in the lengthwise direction of the protrusion 200 satisfies p<0.4 W Alternatively, p<0.3 W may be employed. p<0.3 W can increase the amount of airflow AR flowing from the outside to the inside of the lateral groove 40A during the rotation in the direction R1 described in Portion (a) of FIG. 5. p<0.4 W can increase the amount of airflow AR flowing from the lateral groove 40A to the outside during the rotation in the direction R2 described in Portion (b) of FIG. 5.

2.00≦W/Lw and 0<Lr/W≦0.5 are satisfied, where W is the pitch of the lateral grooves 40, LW is the length of the protrusion 200 in the tread width direction, and Lr is the length of the protrusion 200 in the tire circumferential direction. It is undesirable to reduce the pitch of the lateral grooves 40 because such reduction makes it difficult for air to enter the lateral groove 40. Moreover, since the protrusion 200 is made of rubber, excessively increasing the width of the protrusion 200 may lead to poor heat dissipation performance.

### (4) Modifications

### (4-1) Block Shape

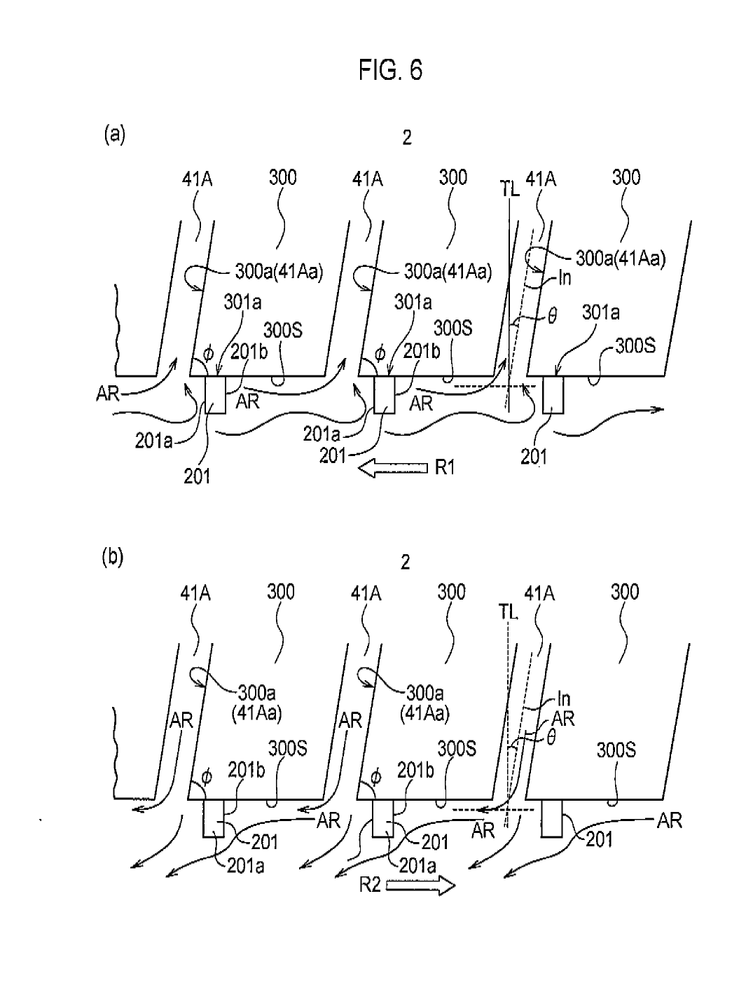

FIG. 6 is a plan view of a pneumatic tire 2 seen in a direction perpendicular to its tread portion, the pneumatic tire 2 being shown as a modification of the embodiment. In the pneumatic tire 2, lateral grooves 41A are formed in each of the circumferential land portions 30A, 30B, and 30C. A center line in of each lateral groove 41A extending in the extending direction of the lateral groove 41A is tilted at an angle θ with respect to a tread-width-direction line TL extending in the tread width direction. Moreover, a protrusion 201 is provided in an end-portion region 301a of each land-portion block 300 on a side where an angle cp between a side surface 300s and a side surface 300a (a wall surface 41Aa of the lateral groove 41A) of the land-portion black 300 is an acute angle.

Portion (a) of FIG. 6 is a schematic view describing airflows generated when the pneumatic tire 2 is rotated in the rotation direction R1, while Portion (b) of FIG. 6 is a schematic view describing airflows generated when the pneumatic tire 2 is rotated in the rotation direction R2.

As shown in Portion (a) of FIG. 6, when the pneumatic tire 2 is rotated in the rotation direction R1, airflows (relative winds) AR resulting from the rotation hit side surfaces 201a of the protrusions 201 and are taken into the lateral grooves 41A. Since the lateral grooves 41A are tilted, the airflows AR are more likely to be taken into the lateral grooves 41A.

Moreover, as shown in Portion (b) of FIG. 6, when the pneumatic tire 1 is rotated in the rotation direction R2, airflows (relative winds) AR resulting from the rotation hit side surfaces 201b of the protrusions 201 and flow over the protrusions 201. When this occurs, an airflow toward the outer side in the width direction is generated in the rear, in the rotation direction, of the side surface 201b of each of the protrusions 201. These airflows draw air through the lateral grooves 41A and thus generate the airflows AR flowing outward from the lateral grooves 41A. Moreover, since the lateral grooves 41A are tilted, the air is more likely to flow outward from the lateral grooves 41A. As a result, the heat transfer coefficient inside the lateral grooves 41A is improved. Accordingly, the effect of lowering the temperature of the land-portion blocks 300 can be enhanced.

### (4-2) Arrangement of Protrusions

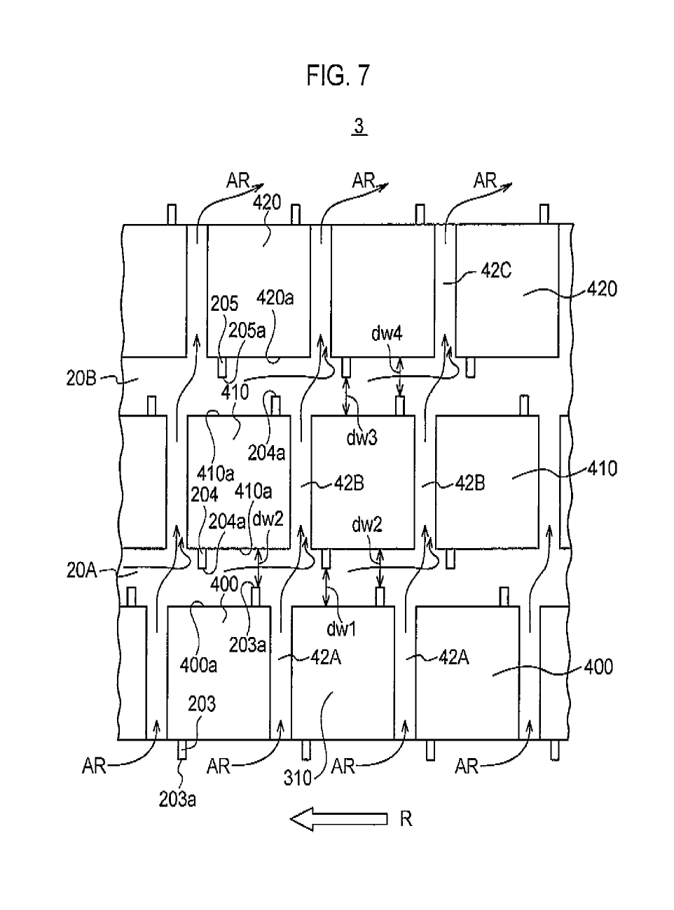

FIG. 7 is a plan view of a pneumatic tire 3 seen in a direction perpendicular to its tread portion, the pneumatic tire 3 being shown as a modification of the embodiment. The pneumatic tire 3 includes: bead portions; sidewall portions continuously extended from the bead portions, respectively; a tread portion configured to come into contact with the road surface; and buttress portions extending inward in the tire radial direction from tread end portions, which are outer end portions of the tread portion in the tread width direction, and continuously extended from the sidewall portions, respectively.

Formed in the tread portion of the pneumatic tire 3 are: multiple lateral grooves 42A, 42B, and 42C crossing the tire circumferential direction; circumferential grooves 20A and 20B extending in the tire circumferential direction; and land portions 400, 410, and 420 defined by the lateral grooves 42A, 42B, and 420 and the circumferential grooves 20A and 20B extending in the tire circumferential direction.

In the pneumatic tire 3, protrusions 203 are formed on the side surfaces of the land portions 400, 410, and 420, respectively, the side surfaces crossing a tread witch direction W. The protrusions 203 protrudes in the tread width direction W from the side surfaces of the land portions 400, 410, and 420 and extends in the tire radial direction.

An air gap dw2 is formed between an outermost portion 203a which is the most protruded portion of the protrusion 203 from a side surface 400a of its land portion 400 in the tread width direction, and a side surface 410a of the land portion 410 adjacent in the tread width direction, the side surface 410a crossing the tread width direction.

Similarly, an air gap dw1 is formed between an outermost portion 204a and the side surface 400a. Moreover, an air gap dw4 is formed between the other outermost portion 204a and a side surface 420a. Furthermore, an air gap dw3 between an outermost portion 205a and the other side surface 410a.

As described above, in the pneumatic tire 3, the protrusions 203, 204, and 205 are formed on the side surfaces 410a, 420a, and 430a of the land portions 400, 410, and 420. Thus, air flowing over the surface of the tire and through the circumferential grooves 20A and 30B hits the protrusions 203, 204, and 205 and gets disturbed. Since the protrusions 203, 204, and 205 are formed near the lateral grooves 42A, 42B, and 42C formed between the land portions 400, 410, and 420, airflows around the tire are disturbed by the protrusions 203, 204, and 205 and thereby taken into the lateral grooves 42A, 42B, and 42C.

The air gaps dw1 to dw4 are formed between the outermost portions 203a, 204a, and 205a, which are the most protruded portions from the side surfaces 400a, 410a, and 420a in the tread width direction, and the side surfaces opposite thereto. Thus, air taken into the circumferential grooves 20A and 30B flows into the lateral grooves 42A, 42B, and 42C. As a result, the heat transfer coefficients inside the lateral grooves 42A, 42B, and 42C are improved. Accordingly, the temperatures of the land portions 400, 410, and 420 can be lowered. Further, the temperature of the tread portion can be lowered.

The protrusion 203 can be provided on one side of the side surface of the land-portion block 400 at a position where an airflow AR is more likely to be taken in, and also on the other side of the side surface of the land-portion block 400 at a position where an airflow AR is more likely to be formed in a direction to suck air out. The air gaps dw1 to dw4 may all be the same or different.

### (5) Other Embodiments

As described above, the contents of the present invention have been disclosed through an embodiment of the present invention. However, it should not be understood that the description and drawings which constitute part of this disclosure limit the present invention. From this disclosure, various alternative embodiments and examples will be apparent to those skilled in the art. For example, the embodiment of the present invention can be changed in the following ways.

The pneumatic tire according to the embodiment can be significantly effective when applied to what is called a giant tire, but the pneumatic tire can be applied to a general-purpose tire. By forming protrusions protruding in the tread width direction in each buttress portion, it is possible to improve the heat transfer coefficient of the pneumatic tire and thus reduce increase in the temperature of the tread surface under a situation such as traveling at a high speed or traveling on a rough road in which the tread is more likely to generate heat.

The tread pattern of the pneumatic tire 1 shown in FIG. 1 has been presented as a typical example. However, the present invention is not limited to this tread pattern. For example, it is possible to employ a type including a rib-shaped land portion having no lateral grooves formed around the tire equator line of the pneumatic tire 1.

The above embodiment has described that the lateral groove portions (the lateral grooves 40, the lateral grooves 41, the lateral grooves 42, etc.) are all formed at the same angle with respect to the tire circumferential direction. However, in the same pneumatic tire, the angles of the lateral groove portions with respect to the tire circumferential direction may not necessarily be the same. For example, they may be formed at angles that differ among the circumferential land portions 30A, 30B, and 30C. Further, lateral groove portions with a different angle may be formed only in the circumferential land portion 30A.

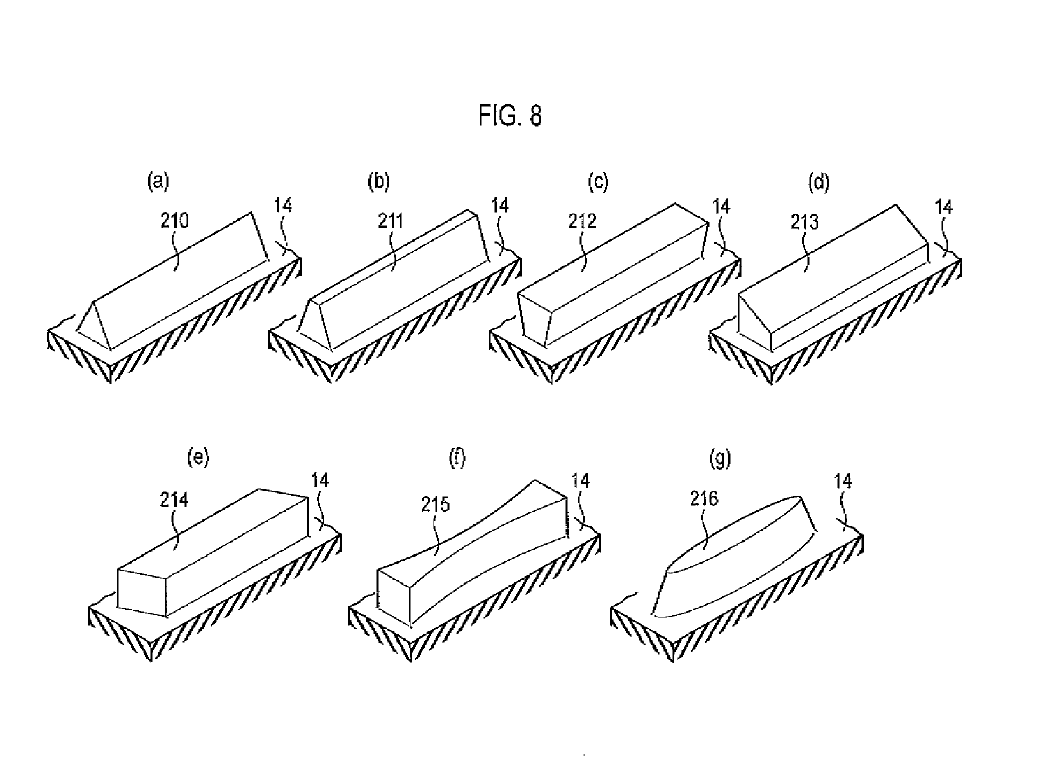

FIGS. 1 to 5 mentioned above have shown that the shape of each protrusion is rectangular. However, the protrusion can be modified as below. Portions (a) to (g) of FIG. 8 are perspective views showing modifications of the shape of the protrusion.

In the case of a protrusion 210 shown in Portion (a) of FIG. 8, the cross-sectional shape perpendicular to the lengthwise direction of the protrusion 210 is a triangular shape. In the case of a protrusion 211 shown in Portion (b) of FIG. 8, the cross-sectional shape perpendicular to the lengthwise direction of the protrusion 211 is a trapezoidal shape with its long side being the root of the protrusion 211 attached to the buttress portion 14. In the case of a protrusion 212 shown in Portion (c) of FIG. 8, the cross-sectional shape perpendicular to the lengthwise direction of the protrusion 212 is a trapezoidal shape with its short side being the root of the protrusion 212 attached to the buttress portion 14. In the case of a protrusion 213 shown in Portion (d) of FIG. 8, the cross-sectional shape perpendicular to the lengthwise direction of the protrusion 213 is a shape having a slope facing one side in a rotation direction. A protrusion 214 shown in Portion (e) of FIG. 8 has a parallelogram shape in a plan view seen in a direction along the axis of rotation of the tire. A protrusion 215 shown in Portion (f) of FIG. 8 has a shape having a smaller width at a center portion in the lengthwise direction than at end portions in the lengthwise direction, in a plan view seen in the direction along the axis of rotation of the tire. A protrusion 216 shown in Portion (g) of FIG. 8 has an elliptical shape in a plan view seen in the direction along the axis of rotation of the tire. Structures other than those described in the above examples can be employed as long as they can produce the effect of disturbing air flowing over the surface of the tire.

As described above, the present invention naturally includes various embodiments and the like which are not described herein. Accordingly, the technical scope of the present invention is determined only by the matters to define the invention in the claims regarded as appropriate based on the above description.

Note that the entire content of Japanese Patent Application No. 2010-189647 (filed on Aug. 26, 2010) is incorporated herein by reference.

### INDUSTRIAL APPLICABILITY

The present invention can provide a tire capable of securely achieving improved heat dissipation performance without impairing the rigidity and wear resistance of its tread portion.

1. A tire comprising:
a bead portion;
a sidewall portion continuously extended from the bead portion;
a tread portion that comes into contact with a road surface; and
a buttress portion extending inward in a tire radial direction from a tread end portion and continuously extended from the sidewall portion, the tread end portion being an outer end portion of the tread portion in a tread width direction, wherein
a protrusion protruding in the tread width direction is formed in the buttress portion.

2. A tire comprising:
a bead portion;
a sidewall portion continuously extended from the bead portion;
a tread portion that comes into contact with a road surface; and
a buttress portion extending inward in a tire radial direction from a tread end portion and continuously extended from the sidewall portion, the tread end portion being an outer end portion of the tread portion in a tread width direction, wherein
a rotation direction of the tire during forward travel of a vehicle is fixed,
a plurality of lateral groove portions, a circumferential groove portion, and land portions are formed in the tread portion, the lateral groove portions crossing a tire circumferential direction, the circumferential groove portion extending in the tire circumferential direction, the land portions being defined by the lateral groove portions and the circumferential groove portion,
a protrusion is formed on a side surface of each of the land portions that crosses the tread width direction, the protrusion protruding in the tread width direction from the side surface and extending in the tire radial direction, and
an air gap is formed between a most protruded portion of the protrusion from the side surface in the tread width direction and a side surface of an adjacent land portion in the tread width direction crossing the tread width direction.

3. The tire according to claim 1 or 2, wherein
the protrusion is formed near the lateral groove located on one side with respect to a center of the land portion in the circumferential direction, and
the other side of the side surface with respect to the center of the land portion in the circumferential direction is almost flat and smooth.

4. The tire according to claim 1 or 2, wherein,
a plurality of lateral groove portions and land portions are formed in the tread portion, the lateral groove portions crossing a tire circumferential direction, the land portions defined by the lateral groove portions,
the protrusion has a rectangular shape extending in the tire radial direction, and
p<0.4 W is satisfied, where p is a length, within a section of the land portion defined by the lateral groove portions, from an end portion of the side surface in the tire circumferential direction to a protrusion center line set at a center of the protrusion in the tire circumferential direction and extending in a lengthwise direction of the protrusion, and W is a pitch of the lateral groove portions between the land portions.

5. The tire according to claim 1 or 2, wherein an angle θ between the protrusion center line and a tire normal line satisfies |θ|≧60°.

6. The tire according to claim 5, wherein the tire normal line coincides with the lengthwise direction of the rectangular shape.

7. The tire according to claim 1 or 2, wherein 2.00≦W/Lw is satisfied, where Lw is a length of the protrusion in the tread width direction, and W is a pitch of the lateral groove portions.

8. The tire according to claim 1 or 2, wherein 0≦Lr≦WB/2 is satisfied, where WB is a length of each of the land portions in the tire circumferential direction, and Lr is a length of the protrusion in the tire circumferential direction.

9. The tire according to claim 1 or 2, wherein 0.10≦Lh/H is satisfied, where Lh is a length of the protrusion in the tire radial direction, and H is a length of each of the land portions in the tire radial direction from a groove bottom of each of the lateral groove portions defining the land portions.

10. The tire according to claim 1 or 2, wherein
the lateral groove portions are tilted with respect to a tread-width-direction line extending in the tread width direction, and
the protrusion is provided in an end-portion region including an end portion of the corresponding land portion on a side where an angle between a side surface of the land portion extending in the tire circumferential direction and a wall surface of the corresponding lateral groove portion is an acute angle.

11. The tire according to claim 1 or 2, wherein
a circumferential groove portion extending in the tire circumferential direction is formed, and
the lateral groove portions communicate with the circumferential groove portion.
